(19) United States
(12) Patent Application Publication
(10) Pub. No.: US 2012/0056707 A1
(43) Pub. Date: Mar. 8, 2012

(54) TRANSFORMER FOR A POWER SUPPLY CONVERTER

(75) Inventors: Sung Bum JUNG, Yongin-si (KR); Sung Yong JOO, Yongin-si (KR); Jin Hyung LEE, Anyang-si (KR); Won Myung WOO, Seoul (KR); Gil Yong CHANG, Suwon-si (KR)

(73) Assignee: SAMSUNG ELECTRONICS CO., LTD., Suwon-si (KR)

(21) Appl. No.: 13/224,760

(22) Filed: Sep. 2, 2011

(30) Foreign Application Priority Data
Sep. 7, 2010 (KR) 10-2010-0087371

(51) Int. Cl. H01F 30/06

(52) U.S. Cl. 336/212

(57) ABSTRACT

A transformer for an LLC resonant converter having a reduced size and reduced material costs is disclosed. The transformer includes a pair of cores and a bobbin provided with a through hole formed therethrough. Each core includes a first leg and a second leg such that the first legs of the cores are opposite from and are connected to each other within the through hole. The second legs of the cores are opposite each other and are connected to each other at the outside of the bobbin. The bobbin includes a first winding unit on which a primary coil is wound and a second winding unit on which a secondary coil is wound.

### CROSS-REFERENCE TO RELATED APPLICATION

This application claims the benefit of Korean Patent Application No. 2010-0087371, filed on Sep. 7, 2010 in the Korean Intellectual Property Office, the disclosure of which is incorporated herein by reference.

### BACKGROUND

1. Field

The exemplary embodiments of the present invention relate to a transformer for a converter used in a power supply device for displays. The transformer achieves both size reduction and material cost reduction through improvement in the shapes of the cores and a bobbin.

2. Description of the Related Art

Recently, customer demand for small and thin electronic products has increased. As such, efforts to reduce the size of a power supply device for displays, such as a plasma display panel (PDP) and a liquid crystal display (LCD), have been made.

Such a power supply device generally includes a DC/DC converter which is provided with a transformer in order to convert a primary voltage, which is input, into a secondary voltage. An (LLC) resonant converter has excellent efficiency and has a comparatively simple circuit configuration. As a result, an LLC resonant converter is used for a display in most power supply devices.

In general, a transformer of an LLC resonant converter includes (EE) cores, a bobbin and coils. That is, two cores, each having an E-shape, are magnetically connected, and a bobbin is provided so as to surround the entirety of the EE cores. Therefore, the transformer occupies a large space in the power supply device.

### SUMMARY

Therefore, it is an aspect of the exemplary embodiments to provide a transformer for a converter that is used in a power supply device for a display, where the transformer has a small size through improvement in the shape of the cores and the bobbin. This results in a transformer for an LLC resonant converter which has reduced material costs.

Additional aspects of the exemplary embodiments will be set forth in part, in the description which follows and, in part, will be obvious from the description, or may be learned by practice of the exemplary embodiments.

In accordance with one aspect of the exemplary embodiments, a transformer for a converter includes a pair of cores and a bobbin provided with a through hole formed therethrough, wherein each core includes a first leg and a second leg such that the first legs of the cores are opposite each other and are connected to each other within the through hole. In addition, the second legs of the cores are opposite and are connected to each other at the outside of the bobbin. The bobbin includes a first winding unit on which a primary coil is wound and a second winding unit on which a secondary coil is wound.

The second legs may have a height greater than that of the first legs and may have a width smaller than that of the first legs.

The first and second winding units may include first and second slot parts on which the respective coils are wound. The first and second slot parts may be provided between a pair of diaphragms which extend from the outer circumferential surface of the bobbin.

The diaphragms may have a height corresponding to the height of the cores.

The bobbin may further include a first support plate and a second support plate which respectively extended from side ends of the first and second winding units. The first and second support plates may include support pins for fixing the transformer to an external printed circuit board.

The first and second support plates may respectively extend from the side ends of the first and second winding units such that a width of the first and second support plates corresponds to a width of the cores.

A single magnetic flux loop may be formed. The converter may be an LLC resonant converter. The first and second legs may have a circular or rectangular cross-section.

In accordance with another aspect of the exemplary embodiments, a transformer for a converter includes a bobbin provided with a through hole formed therethrough and a winding unit provided on the outer circumferential surface thereof, and a pair of U-shaped cores, each of which is provided with one end and another end, such that the ends of the U-shaped cores are opposite to each other and are connected to each other within the through hole. The other ends of the U-shaped cores are opposite and are connected to each other at the outside of the bobbin in order to form a single magnetic flux loop passing through the through hole.

The winding unit may include first and second slot parts formed on the outer circumferential surface thereof on which the coils are wound, and diaphragm parts extended from the outer circumferential surface of the bobbin so as to divide the first and second slot parts from each other.

The diaphragm parts may have a height corresponding to a height of the cores.

The bobbin may include first and second support plates which extend, respectively, from both side ends of the winding unit. The first and second support plates may include support pins for fixing the transformer to an external printed circuit board.

The first and second support plates may extend, respectively, from the side ends of the first and second winding units such that a width of the first and second support plates corresponds to a width of the cores.

The converter may be an LLC resonant converter.

### BRIEF DESCRIPTION OF THE DRAWINGS

These and/or other aspects of the exemplary embodiments will become apparent and will be more readily appreciated from the following description of the embodiments, taken in conjunction with the accompanying drawings of which:

FIG. 1A is a perspective view of a transformer for a converter, in accordance with one exemplary embodiment;

FIG. 1B is an exploded perspective view of the transformer, in accordance with the exemplary embodiments;

FIG. 1C is a side view of the transformer, in accordance with the exemplary embodiments;

FIG. 2 is a view illustrating a core of the transformer, in accordance with the exemplary embodiments;

FIG. 3A is a perspective view of a bobbin of the transformer, in accordance with the exemplary embodiments;

FIG. 3B is a front view of the bobbin of the transformer, in accordance with the exemplary embodiments;

FIG. 4 is a view illustrating a magnetic flux of the transformer, in accordance with the exemplary embodiments; and

FIGS. 5A to 5C are views illustrating cores of transformers for converters, in accordance with other exemplary embodiments.

### DETAILED DESCRIPTION

Reference will now be made in detail to the exemplary embodiments, examples of which are illustrated in the accompanying drawings, wherein like reference numerals refer to like elements throughout.

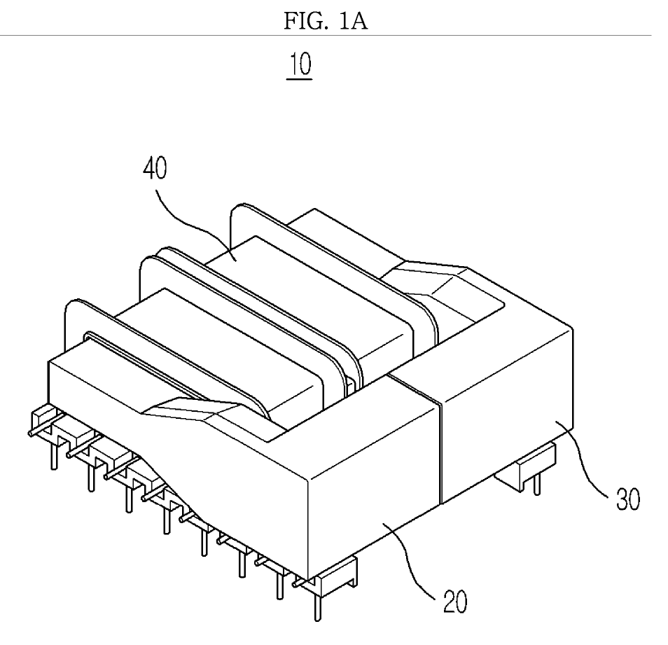

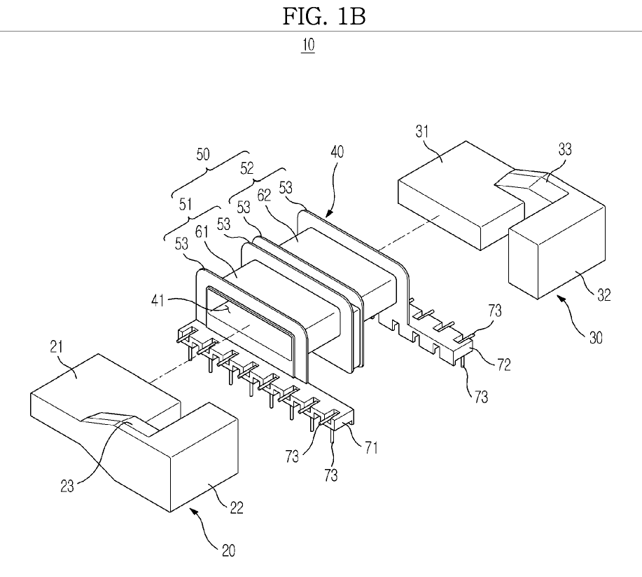

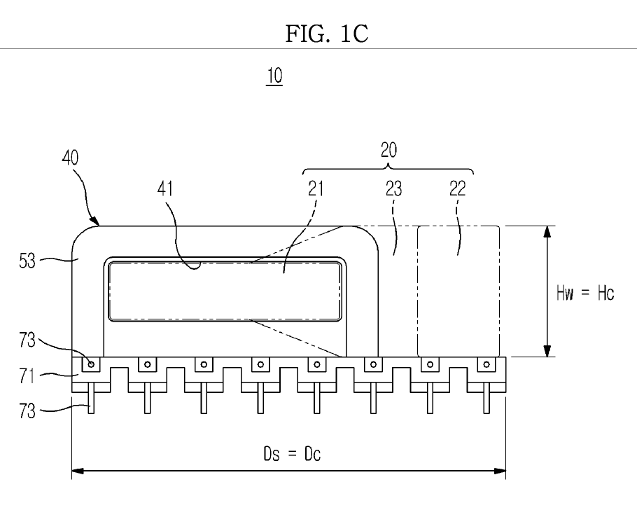

FIG. 1A is a perspective view of a transformer for a converter in accordance with one exemplary embodiment. FIG. 1B is an exploded perspective view of the transformer in accordance with an exemplary embodiment. FIG. 1C is a side view of the transformer in accordance with an exemplary embodiment.

With reference to FIGS. 1A to 1C, a transformer 10 for a converter in accordance with this exemplary embodiment includes a pair of cores 20 and 30 and a bobbin 40.

Cores 20 and 30 are ferrite cores having an approximately U-shape, and when current flows along coils, a magnetic flux flows along cores 20 and 30. Cores 20 and 30 in a pair have the same shape and are symmetrical to each other. Thereby, cores 20 and 30 are simply manufactured and easily assembled.

Cores 20 and 30 in the pair include first legs 21 and 31 and second legs 22 and 32, respectively. First legs 21 and 31 and the second legs 22 and 32 are electrically connected by connection parts 23 and 33.

Cores 20 and 30 in the pair are connected such that first legs 21 and 31 are opposite each other and second legs 22 and 32 are opposite each other, such that a single magnetic flux loop is formed. An impregnation solution is applied to a bonding surface between cores 20 and 30, thereby firmly fixing cores 20 and 30 together.

Bobbin 40 is a cylindrical case on which coils are wound, and is provided with a through hole 41 formed therethrough. A winding unit 50 is provided on the outer circumferential surface of bobbin 40, such that a primary coil and a secondary coil are wound on winding unit 50.

First legs 21 and 31 of cores 20 and 30 are inserted into through hole 41. Then, first legs 21 and 31 are connected to each other at an approximately central portion of through hole 41.

As a result of the above configuration, transformer 10 in accordance with an embodiment is configured such that both the primary coil and the second coil are wound on one leg 21 or 31 of each of the cores 20 and 30.

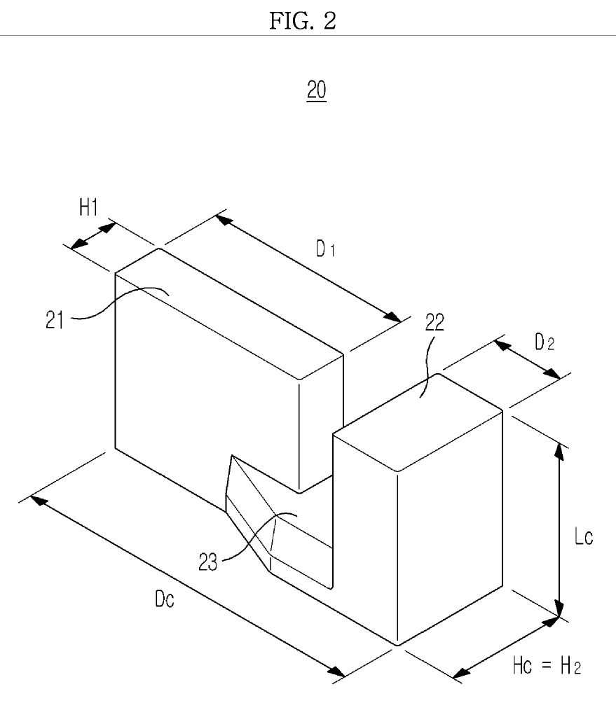

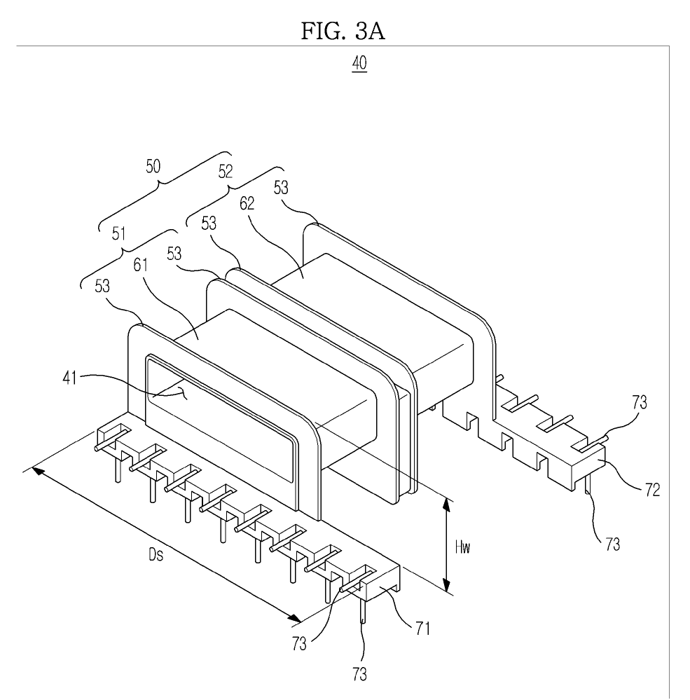

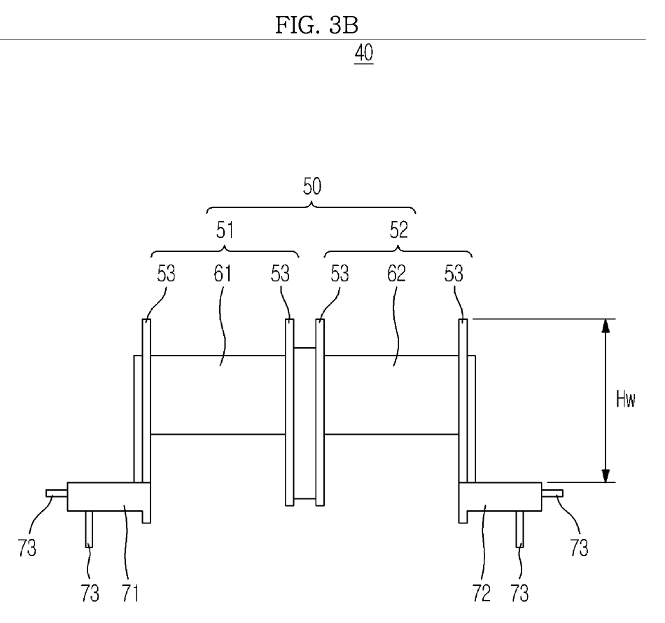

FIG. 2 illustrates the core of the transformer, in accordance with an exemplary embodiment. FIG. 3A is a perspective view of the bobbin of the transformer, in accordance with an exemplary embodiment. FIG. 3B is a front view of the bobbin of the transformer, in accordance with an exemplary embodiment.

With reference to FIGS. 2 to 3B, structures of core 20 and bobbin 40 of the transformer will be described in accordance with this exemplary embodiment.

Core 20 includes two legs 21 and 22 which are provided in parallel and are connected to each other by connection part 23. First leg 21 is provided to have an approximately flat rectangular cross-section, which corresponds to the cross-section of through hole 41 such that first leg 21 is inserted into through hole 41 of bobbin 40. Second leg 22 is configured to have an approximately rectangular cross-section. A height H₂ of second leg 22 is greater than a height H₁ of first leg 21, and a width D₂ of second leg 22 is smaller than a width D₁ of the first leg. Further, second leg 22 is disposed at the outside of bobbin 40 and is connected to second leg 32 of other core 30.

Winding unit 50 is provided on the outer circumferential surface of bobbin 40 such that the primary coil and the secondary coil are wound on winding unit 50.

Winding unit 50 is divided into a first winding unit 51 on which the primary coil is wound and a second winding unit 52 on which the secondary coil is wound. First winding unit 51 includes a first slot part 61 having a flat shape such that the primary coil is wound on first slot part 61. The first slot part 61 is provided between diaphragm parts 53 extended outward integrally from the outer circumferential surface of bobbin 40. In the same manner as first winding unit 51, second winding unit 52 includes a second slot part 62. First winding unit 51 and second winding unit 52 may be separated from each other by a proper interval so as to be insulated from each other.

First and second support plates 71 and 72 extended in the vertical direction integrally from both diaphragms 53 at both sides of bobbin 40 are provided on the lower surface of bobbin 40. A plurality of support pins 73 is provided in the vertical and horizontal directions on each of support plates 71 and 72, in order to fix the transformer 10 to an external printed circuit board.

Width Ds of support plates 71 and 72 are approximately the same as a width Dc of cores 20 and 30.

Further, a height Hw of diaphragms 53 from support plates 71 and 72 is approximately the same as a height Hc of the cores 20 and 30. Through the above configuration, transformer 10, in accordance with this exemplary embodiment, has an approximately rectangular parallelepipedal shape. Thus, space utility of the transformer in an electronic component is increased.

In FIG. 2, reference numeral Lc represents a length of the core.

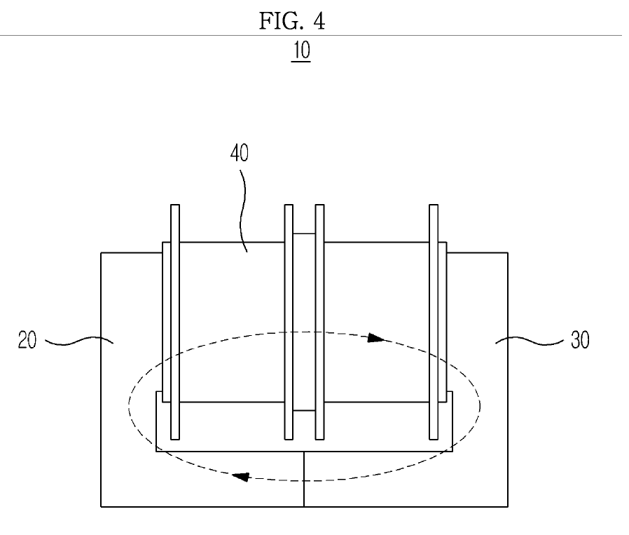

FIG. 4 is a view illustrating a magnetic flux of the transformer, in accordance with an exemplary embodiment.

As shown in FIG. 4, the transformer in accordance with this embodiment forms a single magnetic flux loop. Differing from a conventional transformer for a converter which forms two magnetic fluxes by winding a coil on a central leg of an E-shaped core, the transformer in accordance with this embodiment forms a single magnetic flux loop, thereby providing an advantage in that core 20 is designed such that temperatures of respective parts of core 20, according to change in magnetic flux density, are optimized.

As described above, the transformer in accordance with this embodiment requiring thin film and small size usage of U-shaped cores, as well as a bobbin having a shape corresponding to the U-shaped cores, thus reducing the sizes of the cores and the bobbin while having the same electrical characteristics as a conventional transformer using E-shaped cores.

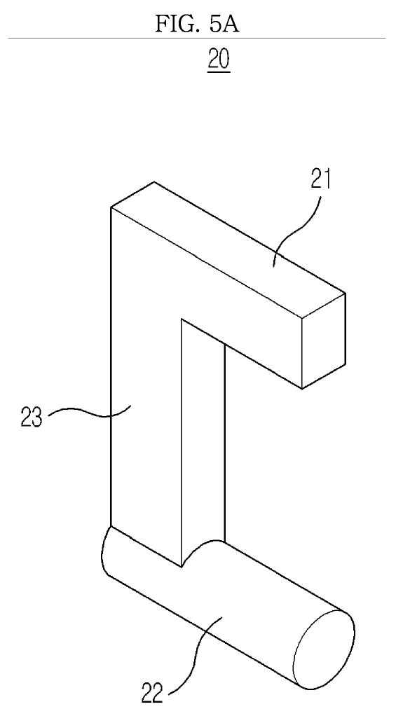

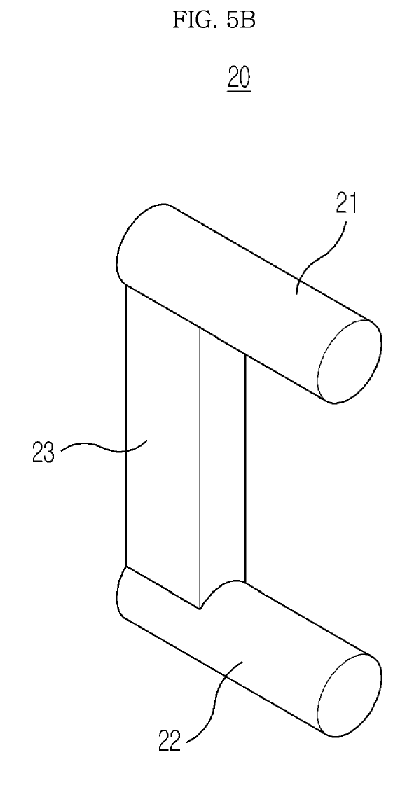

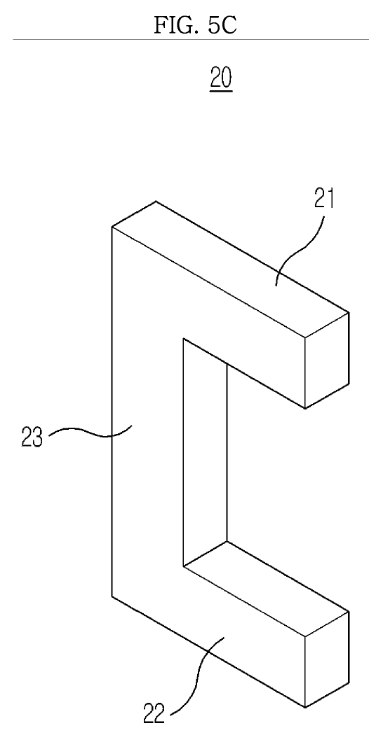

In addition to this embodiment, transformers for converters in accordance with other embodiments include U-shaped cores having rectangular and circular cross-sections and bobbins corresponding to the shapes of the U-shaped cores, as shown FIGS. 5A to 5C.

As is apparent from the above description, a transformer for a converter in accordance with one exemplary embodiment uses U-shaped cores and thus has a reduced size, while having the same electrical characteristics as a conventional transformer for a converter, thereby achieving miniaturization of a power supply device for displays and an electronic component.

Further, the transformer reduces the size of the bobbin and the cores. The number of bonding points and usage amounts of an impregnation solution and a bobbin tape are reduced, thereby achieving a reduction in material costs.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A transformer for a converter, the transformer comprising:
a pair of cores and a bobbin provided with a through hole formed therethrough,
each core includes a first leg and a second leg such that the first legs of the cores are opposite and are connected to each other within the through hole and the second legs of the cores are opposite and are connected to each other at the outside of the bobbin; and
the bobbin includes a first winding unit on which a primary coil is wound and a second winding unit on which a secondary coil is wound.

2. The transformer according to claim 1, wherein the second legs have a height greater than the height of the first legs; and
said second legs have a width smaller than the width of the first legs.

3. The transformer according to claim 1, wherein each of the first and second winding units include first and second slot parts on which the respective coils are wound; and
the first and second slot parts are provided between diaphragms extended from the outer circumferential surfaces of the bobbin.

4. The transformer according to claim 3, wherein the diaphragms have a height corresponding to the height of the cores.

5. The transformer according to claim 1, wherein the bobbin further includes a first support plate and a second support plate respectively extended from side ends of each of the first and second winding units; and
the first and second support plates include support pins configured for fixing the transformer to an external printed circuit board.

6. The transformer according to claim 5, wherein the first and second support plates respectively extend from side ends of the first and second winding units such that a width of the first and second support plates corresponds to a width of the cores.

7. The transformer according to claim 1, wherein a single magnetic flux loop is formed.

8. The transformer according to claim 1, wherein the converter for the transformer is an LLC resonant converter.

9. The transformer according to claim 1, wherein each of the first and second legs have a circular or rectangular cross-section.

10. A transformer for a converter, the transformer comprising:
a bobbin provided with a through hole formed therethrough and a winding unit provided on the outer circumferential surface thereof;
a pair of U-shaped cores, each of which is provided with one end and an other end such that the ends of the U-shaped cores are opposite each other and are connected to each other within the through hole; and
the other ends of the U-shaped cores are opposite and are connected to each other at the outside of the bobbin to form a single magnetic flux loop passing through the through hole.

11. The transformer according to claim 10, wherein the winding unit includes first and second slot parts formed on the outer circumferential surface thereof on which coils are adapted to be wound, and diaphragm parts extend from the outer circumferential surface of the bobbin in order to divide the first and second slot parts from each other.

12. The transformer according to claim 11, wherein the diaphragm parts have a height corresponding to a height of the cores.

13. The transformer according to claim 10, wherein the bobbin includes first and second support plates, which respectively extend from both side ends of the winding unit; and
the first and second support plates each include support pins for fixing the transformer to an external printed circuit board.

14. The transformer according to claim 13, wherein the first and second support plates respectively extend from side ends of the first and second winding units, such that a width of the first and second support plates corresponds to a width of the cores.

15. The transformer according to claim 10, wherein the converter for the transformer is an LLC resonant converter.
